(19) United States
(12) Patent Application Publication
(10) Pub. No.: US 2005/0015978 A1
(43) Pub. Date: Jan. 27, 2005

(54) Method and apparatus for producing stranded aluminum cables

(76) Inventors: Ryan Andersen, Williamsport, PA (US); Richard Baker, Alpharetta, GA (US); Danny S. Elder, Montoursville, PA (US); Norman Wesley Zinck JR., Sedalia, MO (US)

Correspondence Address: Christopher C. Dunham;c/o Cooper & Dunham LLP, 1185 Ave. of the Americas, New York, NY, 10036, US

(21) Appl. No.: 10/624,881

(22) Filed: Jul. 21, 2003

(51) Int. Cl. H01R 43/00

(52) U.S. Cl. 29/868; 29/861

(57) ABSTRACT

A method of producing a range of stranded aluminum cables of different gauge from aluminum wires all of the same cross-sectional area. The method involves assembling and stranding a first set of the wires to form a first cable and subsequently assembling and stranding other sets of the wires to form additional cables. Prior to the assembling of at least one set of the wires for the formation of at least one of the cables, the wires are reduced in cross-sectional area in at least two rolling steps, each rolling step causing a reduction in cross-sectional area less than an amount at which brittleness of the wires commences, preferably less than 40% reduction, preferably no more than 30% and ideally less than 25%. The invention also relates to an apparatus for carrying out the method.

### BACKGROUND OF THE INVENTION

I. Field of the Invention

This invention relates to the production of aluminum cables used as electrical conductors and the like. More particularly, the invention relates to the production of such cables made up of multiple individual wire strands arranged in layers.

II. Background Art

Electrical cables are formed by collecting together a number of individual metal wires, e.g. wires made of aluminum or aluminum alloy. This can be done in many ways, but one preferred way is to create one or more layers of wires twisted around a single central core wire or other core element. Cables produced in this way are usually provided with an insulating coating made, for example, of plastics material or rubber, in order to produce final insulated cables.

Double twist stranding (DTS) equipment has been developed to produce cable of this kind. This type of equipment has tended to replace tubular stranding equipment because of the lower cost of production that can thereby be achieved. DTS equipment has proven very effective at producing conventional, compressed and compact stranded cables using a conventional number of wire elements. However, when the equipment is used to produce cables of several different standard sizes (i.e. American Wire Guide (AWG) sizes or metric equivalent sizes expressed in square millimetres), input wires of different sizes are required, i.e. one input wire size is normally required for each different cable gauge. This is disadvantageous from the point of view of cost, simplicity and inventory control. If so-called single input (or incoming) wire (SIW) is used for cable of several different sizes, the wire is typically suited for cable of only one size when a conventional wire format is employed. In order to produce compressed or compact cables of other sizes, it has been necessary to vary the number of wire elements and/or to significantly change the shape of the elements to trapezoid, semi-circular, etc. The cable is then different in appearance and make-up, and it no longer meets standard cable definitions and customer specifications. For example, a typical cable produced using conventional stranding would be a 4/0 AWG cable containing 19 wire elements as a three-layer construction (one core wire, with six wires over the core and twelve wires over the six-wire layer). Cables produced using a round single input wire (i.e. wires all of the same size) for a variety of cable gauges may have to be produced with more or fewer elements than normal and include highly compacted cores with round or formed wire outer layers. Such constructions force manufacturers to attempt to obtain industry specification changes that typically take years to achieve.

### SUMMARY OF THE INVENTION

There is therefore a need for a method and apparatus for producing cables of conventional specifications and format using input wire of a single size (or just a very few different sizes) for cables of many different final gauges. It is an object of the present invention to provide such a method and apparatus.

According to one aspect of the invention, there is provided a method of producing at least two stranded aluminum cables of different gauge from aluminum wires all of the same initial cross-sectional area, which comprises assembling and stranding a first set of the wires all of the same initial cross-sectional area to form a first cable and subsequently assembling and stranding at least one other set of the wires all of the same initial cross-sectional area, and of the same initial cross-sectional area as the wires of the first set, to form at least one other cable, wherein, while assembling at least one set of the wires for the formation of at least one of the cables, the wires are reduced in cross-sectional area in at least two rolling steps, each rolling step causing a reduction in cross-sectional area of the wires less than an amount at which brittleness of the wires is produced.

By the term “brittleness” we mean the tendency of a metal to fracture without undergoing appreciable plastic deformation. Unacceptable brittleness is evidenced by the failure of the wires to meet any of the requirements for use in electrical cables, such as elongation, tensile strength, formability (e.g. ability of a wire to wrap around itself without cracking), etc. There are accepted standards for wires used in electrical cables, so the wires of the present invention, after the rolling passes, should meet such requirements.

According to another aspect of the present invention, there is provided a method of producing at least two stranded aluminum cables of different gauge from aluminum wires all of the same cross-sectional area, which comprises assembling and stranding a first set of the wires to form a first cable and subsequently assembling and stranding at least one other set of the wires to form at least one other cable, wherein, prior to the assembling of at least one set of the wires for the formation of at least one of the cables, the wires are reduced in cross-sectional area in at least two rolling steps, each rolling step producing no more than 40% reduction (and preferably no more than 30% and more preferably no more than 25% reduction) of the cross-sectional area of the wire immediately prior to each rolling step.

According to another aspect of the invention, there is provided a method of producing a stranded aluminum cable of desired final gauge, comprising the steps of: assembling a plurality of individual metal wires of the same initial cross-sectional area, rolling the wires in at least two rolling steps to reduce the initial cross-sectional area of the wires for compatibility with the desired final gauge of the cable, and stranding a cable from said wires of reduced cross-sectional area, wherein each rolling step causes a reduction in cross-sectional area of the wires less than an amount at which brittleness of the wires commences.

By the term “set of the wires”, we mean a group of wires, all of the same cross-sectional area, assembled together to form a cable. However, using the method and apparatus of the present invention, it may be possible to produce cables of different gauge without re-threading the wires through the stranding apparatus, e.g. merely by changing the spacings of rolls used for reducing the cross-sectional size of the wires as required for a particular cable. The set of the wires used for one cable may therefore merely be different regions of the same wires used earlier or later for forming another cable. In the present invention, at least two rolling steps are carried out on preferably each input wire prior to wire assembly and stranding, at least for the production of a cable of at least one gauge size. The rolling steps of the present invention are carried out after a set of cables has been collected together and as they are being fed to stranding apparatus. Normally, the rolling steps are carried out in the cable assembly part of the apparatus (often referred to as the “closing area”) immediately upstream of the stranding or twisting apparatus after the input wires of a set have been withdrawn from individual carriers, baskets, packages, bobbins or spools.

The present invention also provides apparatus for carrying out such a method. Thus, according to another aspect of the invention, there is provided apparatus for producing a stranded metal cable, comprising a supply of metal wires all of the same initial cross-sectional area, equipment for assembling the wires for cable formation, and a machine for stranding the wires into a cable, the apparatus comprising at least two adjustable rolling passes positioned between said supply and said stranding machine, each rolling pass being configured for rolling each wire to reduce the cross-sectional area of the wire by an amount less than that at which brittleness of the wires caused (i.e. 40% or less, preferably 30% or less and most preferably 25% or less).

The rolling passes are preferably adjustable and/or replaceable so that different sets of wires can be subjected to different area reductions in order to make them suitable for assembly into cables of different gauge sizes.

An advantage of the present invention, at least in its preferred forms, is that it can employ wires all of a single input size and shape, or just a small number of inpute wires of different size and possibly shape, to produce a large variety of standard cables of different gauge merely by changing the degree of working of the wires prior to twisting of the wires into standard cable formats.

When working with wires made of aluminium or aluminium alloy, there is a practical limit to the reduction of cross-sectional area that can be achieved in a single step without causing unacceptable reductions of the metal quality, e.g. potential for cracking, fracturing or loss of elongation (generally referred to as “brittleness”). This limit depends on the particular alloy involved, but problems are normally encountered with area reductions of more than 40%, so care must be taken not to exceed this limit (and, for safety, it is preferred not to exceed 30% area reduction). Area reductions of 25% or less are normally acceptable for aluminum alloys of all kinds used for electrical conductors. However, if wires of a single input size (outer diameter or cross-sectional area) are to be used for the formation of cables of a variety of final standard gauges and wire formats, generally more than 30% reduction, and even as much as or more than 50% reduction, in cross-sectional area is likely to be required for the production of cables of some of the desirable gauges.

It has been found that, if the required total reduction of cross-sectional area is achieved using two or more rolling steps rather than just one, with each rolling step accomplishing less than a critical amount of area reduction (i.e. certainly less than 40%, more preferably less than 30%, and ideally less than 25%), then a wire that is of acceptable quality can be produced in sizes suitable for the formation of a variety cables of differing standard gauges. In this way, wires of a single input size, or just a very few input sizes (preferably no more than two), can be used to form cables of a variety of final gauges without having to change the layering pattern of the cable, i.e. the number of wires per layer or the spacing of the wires within the cable, etc. An entirely conventional set of cables of varying gauges can thereby be produced from one or a few kinds of wire, thus reducing cost and complexity. A total reduction of cross-sectional area of up to 75% can be achieved using up to four rolling passes, e.g. by providing three rolling passes each imparting an area reduction of 25%. However, it is normally the case that a broad range of cable sizes can be produced with a total area reduction of no more than about 50%, thus making it possible to provide just two rolling passes each of up to 25% area reduction.

The input wires are normally drawn from metal rod by conventional techniques and are usually of round cross-section. Typically, the rod is of 9.5 mm AA1350, AA6201 or AA8000 series alloy and is drawn to standard sizes (e.g. 0.0982 inch or 0.1240 inch, or metric equivalents) using diamond or tungsten carbide dies. The drawn wire is then normally coiled on bobbins or spools, and then the coils, bobbins or spools are used for supplying a set of input wires to the method and apparatus of the present invention.

When using input wire of this kind, it will normally be possible to form at least one conventional cable of a particular gauge without reducing the cross-sectional area of the wire at all. It may also be possible to produce cables of one or more particular gauges with a size reduction that can be achieved in a single rolling pass. However, the present invention makes it possible to produce cables having a larger number of different gauges, i.e. those gauges which require a reduction of the cross-sectional area of the wire to an extent that cannot safely be achieved in a single rolling step (e.g. 40% or more) without introducing unacceptable metal faults. The method and apparatus of the invention thus provides or enables multiple rolling steps so that such cables can be produced from wire of a single starting size orjust a few starting sizes.

It has furthermore been found advantageous, when using two rolling steps to produce the required final reduction of cross-sectional area and when starting with wire of circular cross-section, to roll the wire to a non-circular cross-section in a first rolling step (while also reducing the area within an acceptable range), e.g. an oval or diamond-shape, and then to roll the wire to a circular cross-section (while also reducing the cross-sectional area to an acceptable extent) in the second rolling step. This helps to reduce “finning”, especially when the wire of non-circular cross-section is rotated through an angle in the range of 45-135°, preferably 85-95°, and ideally 90°, between rolling steps. Alternatively, adjacent roll stands may be mounted at a mutual angle in the stated ranges relative to each other, preferably at 90°, so that twisting of the wire can be avoided.

The cable produced according to the present invention may be subjected to compression or compaction in a known manner, e.g. die compaction or rolling, either during the method as the cable is being assembled, or after assembly and twisting. Typically, the term “compressed” is used to describe a reduction of the outer diameter of a cable by up to 3% from the original uncompressed size. The term “compact” is used for anything greater than a 3% reduction up to a solid conductor which consists of a single wire.

If desired, one or more further rolling steps may be introduced for some or all wires of a set under assembly after the rolling steps used for area reduction. These further rolling steps may be provided primarily in order to change the cross-sectional shape of some or all the wires so that they fit together more compactly to form the cable. For example, some wires may be provided with a trapezoid or triangular cross-sectional shape to better fit together in a stranded layer of a cable. Alternatively, such shapes may be applied to at least some of the wires in the final area-reduction rolling step, i.e. instead of providing the wires with a round cross-section as mentioned above.

Despite the provision of at least two rolling steps in the present invention, it has surprisingly been found that the capabilities of conventional double twisting machines are not usually exceeded. The power required for pulling the wires is reduced if the wires are still coated with a lubricant from the wire drawing process, or if a lubricant is added via a light drip or mist.

The invention will be described in further detail with reference to the drawings and the following description.

### BRIEF DESCRIPTION OF THE DRAWINGS

FIG. 1 is a schematic side view of one embodiment of the cable formation method and apparatus of the present invention;

FIG. 2 is top plan view of the apparatus shown in FIG. 1;

FIG. 3 is an enlarged partial view of rolls 28, 30 of FIGS. 1 and 2;

FIG. 4A shows a reduction of area and a change of shape caused by rolls 28, 30 of FIGS. 1 and 2:

FIG. 4B shows a reduction of area and a change of shape caused by rolls 42, 44 of FIGS. 1 and 2;

FIG. 5 is a vertical cross-section of guide roller 40 of FIGS. 1 and 2;

FIG. 6 is an enlarged partial view of rolls 42, 44 of FIGS. 1 and 2; and

FIG. 7 is a top plan view of apparatus similar to that of FIGS. 1 and 2, but having rolls arranged at 90° to each other and also having additional rolls used for shaping.

### DETAILED DESCRIPTION OF THE PREFERRED EMBODIMENTS

The present invention is intended to be utilized with double twist stranding (DTS) apparatus or other similar stranding apparatus, e.g. a central strander, tubular strander or rigid frame strander. DTS apparatus is well known in the art and is disclosed, for example, in U.S. Pat. Nos. 3,812,666, 4,473,995, 5,260,516 and 5,496,969, as well as PCT patent application WO 95/04185, the disclosures of which are incorporated herein by reference. In the case of a central strander, wire is fed from baskets of wire into the strander (similar to winding a sewing machine bobbin). At the point where the wire is fed, the cross-sectional area of the wire may be adjusted according to the present invention. In the case of tubular and rigid frame stranders, forming rolls may be positioned to work on the wire just prior to closing (final assembly) at the die.

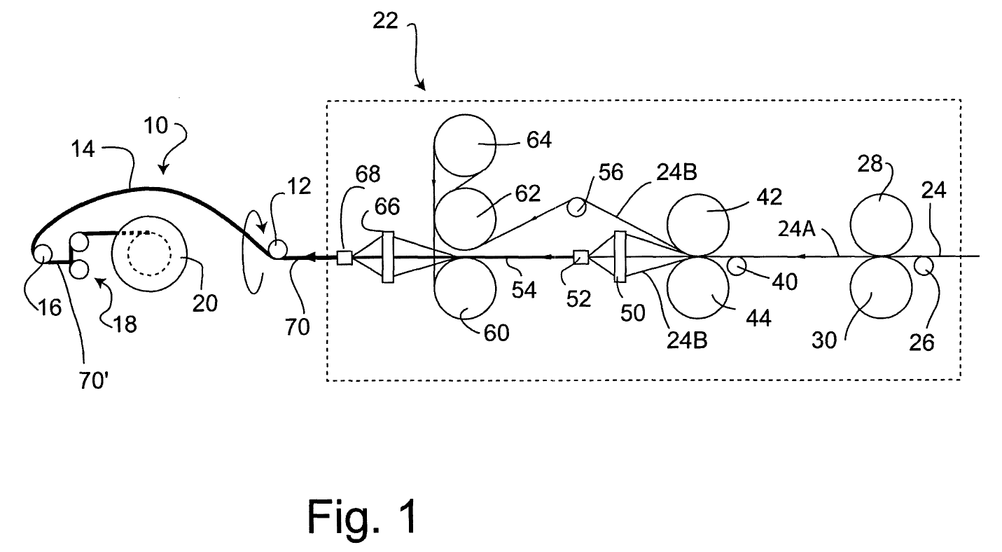

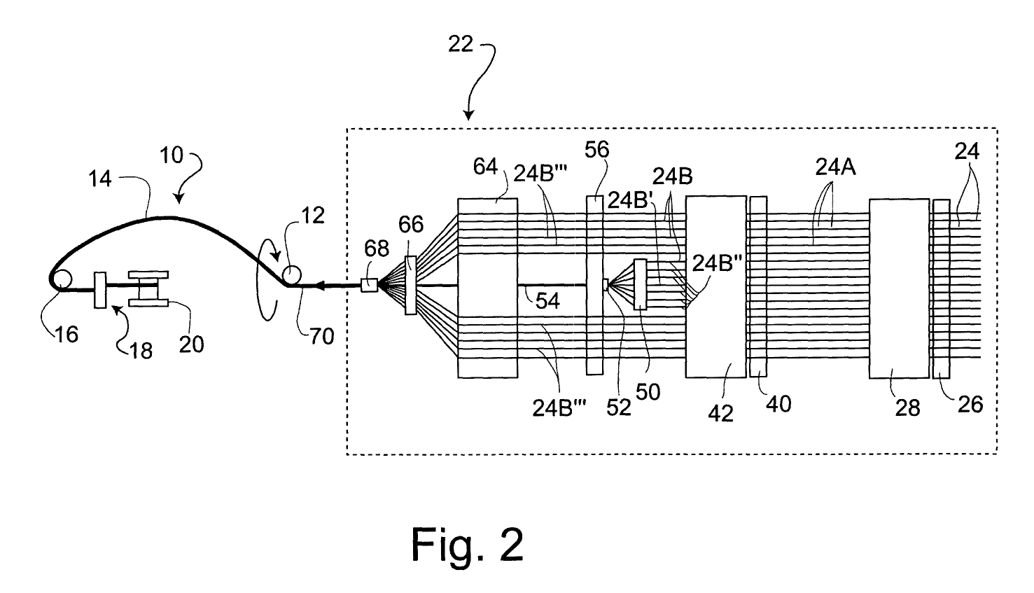

A preferred embodiment of the method of the present invention is illustrated in general terms in FIGS. 1 and 2 of the accompanying drawings. This embodiment of the invention makes use of a double twist stranding (DTS) machine 10 (illustrated in a very simplistic manner). The DTS machine includes an input pulley 12, a bow 14, and output pulley 16, a pulling device 18 and a bobbin 20. The manner in which these elements cooperate and function will be explained later.

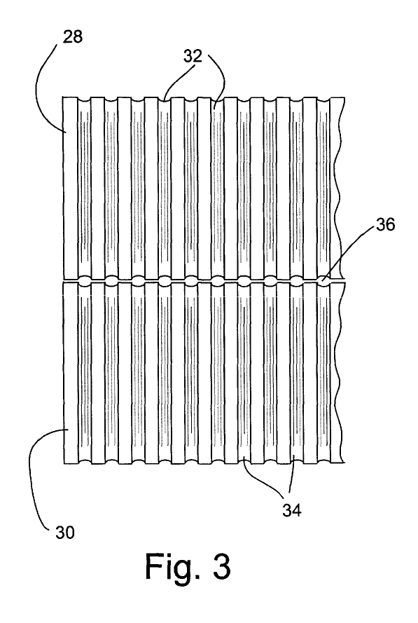

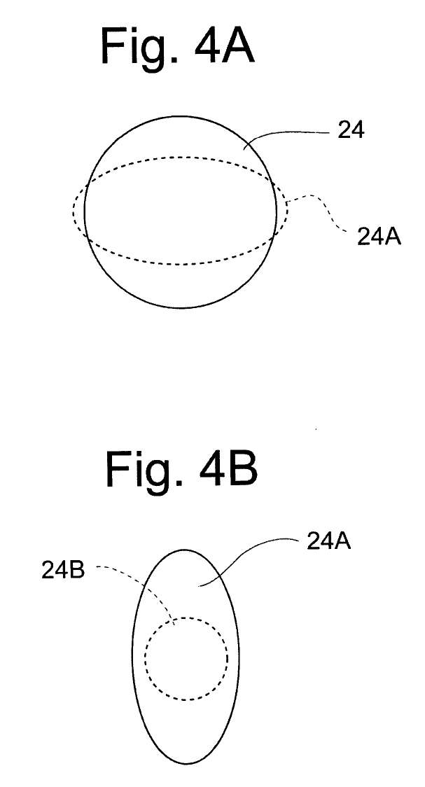

In advance of the DTS machine 10 proper, there is a cable-assembly area 22 (sometimes referred to as a “closing area”). In this area, individual aluminum wires 24 are advanced in spaced parallel relationship over a grooved guide roller 26 and between a first pair of shaping rolls 28 and 30. As shown in the partial view of FIG. 3, the rolls 28 and 30 are provided with aligned pairs of grooves 32 and 34, one pair of grooves for each wire 24. In this embodiment, the grooves are each of semi-elliptical shape and they consequently define a generally elliptical opening 36 between the grooves at the point where the rolls meet. The wires 24 are initially of circular cross-section and they are reduced in cross-sectional area and converted to elliptical cross-sectional shape as they pass between the rollers 28 and 30. This is demonstrated in FIG. 4A of the drawings, where numeral 24 represents the wires in their initial condition and numeral 24A shows the shape and area of the wires as they emerge from between the rollers 28, 30.

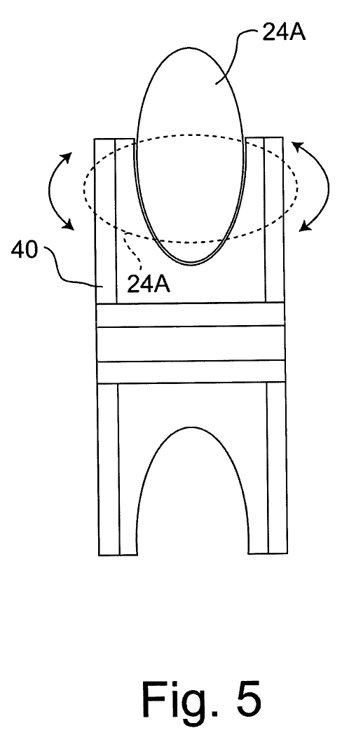

The wires then continue over a further grooved roller 40 which rotates the wires through 90°. This is achieved by providing the grooves of individual rollers 40 with the shape shown in FIG. 5. These rollers have a groove that is of elliptical shape, but with the long axis of the ellipse arranged vertically. As the wires 24A emerge from between rollers 28, 30, they are of elliptical shape, as noted above, but with the long axis of the ellipse arranged horizontally (as shown in broken lines in FIG. 5). To fit within the grooves of the rollers 40, the wires 24A must rotate to the position shown in FIG. 5 in solid lines, i.e. with their long axes arranged vertically.

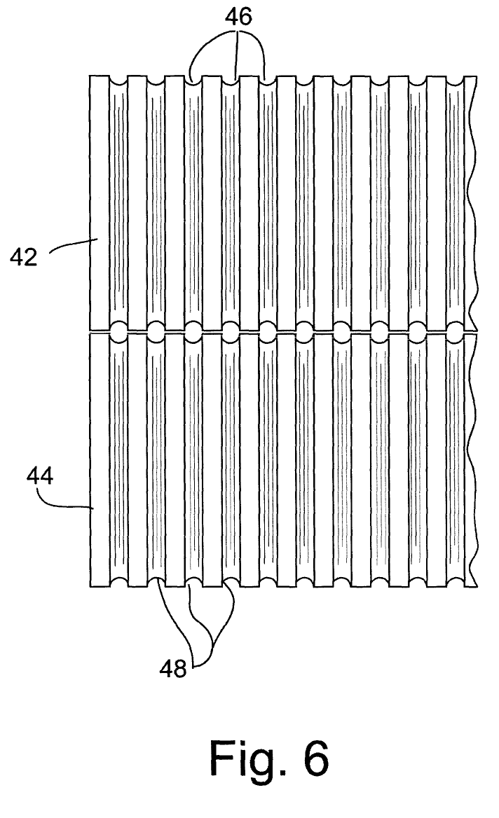

The wires 24A then pass between rolls 42, 44 which are shown in more detail in FIG. 6. The rolls are each provided with grooves 46, 48 that are semi-circular in cross-sectional shape and of smaller area than the wires 24A. As shown in FIG. 4B, the wires 24A compressed and re-shaped as they pass between the rollers 42, 44 and emerge as wires 24B that are again of circular cross-sectional shape and of smaller cross-sectional area than the wires 24A.

The quarter turn rotation of the wires 24A before they pass between rolls 42, 44 reduces the likelihood of “finning”, i.e. part of the metal being squeezed out of the grooves and between the ungrooved part of the rolls 42, 44.

The total effect of passing the wires 24 through the two sets of rolls is to produce wires of circular cross-section that are much smaller in cross-sectional area than the input wires 24A. A significant reduction of area can be achieved without causing metal defects or unusual cross-sectional shapes. Wires 24 of a single input size (or just a very few sizes) can be re-sized as required to produce a variety of final cable gauges. This can be done by adjusting the spacing of the rolls 28, 30 or 42, 44 for small variations, or by replacing the set of rolls 28, 30 or 42, 44 for another set with a different groove cross-sectional area (and possibly shape). Consequently, the same apparatus and input wires all of the same size (or a small number of input wires of different size) can be used to produce stranded cables of essentially all the standard AWG or metric cable sizes using the conventional number of wires per stranded layer. In general, cables of all conventional gauges and format, e.g. from #8AWG to 1000 kcmil (note: above 4/0 AWG, wire sizes are typically designated in kcmil—thousands of circular mils), as well as similar metric sizes, can be produced using just one or two sizes of input wires.

Following the emergence of the wires 24B from between the rollers 42, 44 (as shown in FIG. 2), a central wire 24B′ and three adjacent wires 24B″ on each side of the central wire are passed through a circular perforated stranding plate 50 containing guide rollers which orientate the six adjacent wires 24B″ around the central wire 24B′. The wires assembled in this way are passed through a die 52 to form a cable core 54. The die 52 may optionally apply compression to the cable core 54 to reduce it in cross-sectional area and to shape the central and surrounding wires so that internal free volume is minimized. The remaining 12 wires 24B′″ emerging from between rolls 42, 44 are moved clear of the central wires by passing them over a roller 56, and then these wires pass around an “S-stack” of rolls 60, 62, 64 (see FIG. 1) that provides firm gripping of these wires that are destined to form a third and final layer of strands on the cable core 54. The cable core 54 passes between the rolls of the S-stack and through the central hole of a further perforated circular strand assembly plate 66 containing guide rollers. The 12 wires 24B′″ are positioned by the plate 66 in such a way that they are assembled around the core 54. The wires assembled in this way pass through a further die 68, that again may apply compression to the assembled cable.

The assembled cable 70 then passes around the input pulley 12 of the DTS machine and over the bow 14 as the bow is rotated in the direction shown by the arrow. This rotation twists the cable. The twisted cable then passes around the output pulley 16 of the DTS machine, where a further twisting of the cable takes place. The fully twisted cable 70′ passes around the pulling device 18 and is spooled on the reel 20. The take-up device 18 may include a capstan for pulling the cable and wires through the entire apparatus. The resulting cable has a central core wire, a first layer of six wire strands and an outer layer of 12 wire strands. The cable may be compressed or compacted as desired. Additional layers could be provided in essentially the same way merely by providing more input wires 24 and diverting some of those wires for application following the assembly at plate 66 and die 68.

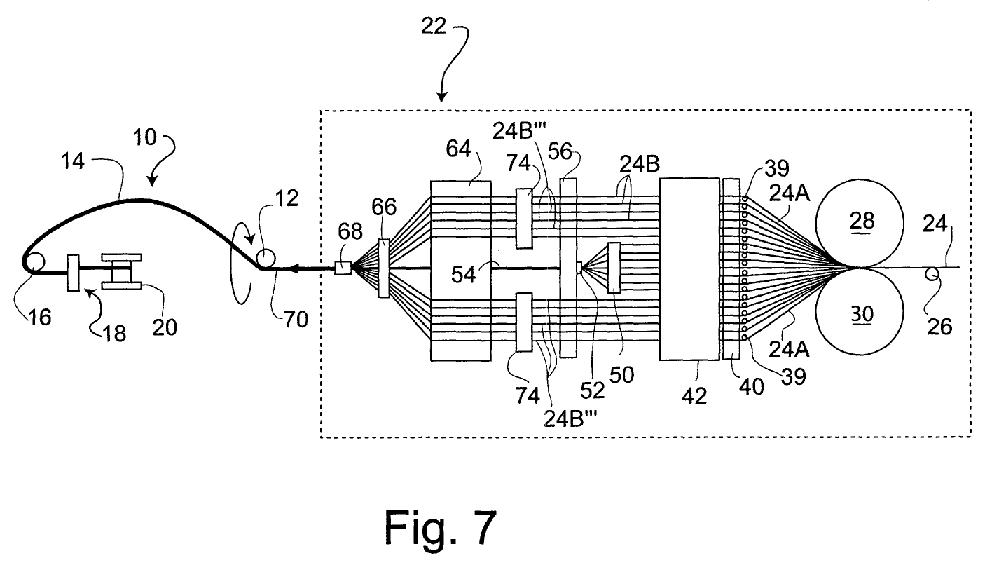

FIG. 7 of the accompanying drawings is similar to FIG. 2, but it shows the use of additional rolls 74 acting only on the twelve outer wires 24B′″. The purpose of these rolls is to provide these wires with a non-circular shape to better fit within the outer layer of the cable. In fact, the rolls 74 can be positioned at any suitable point before the wires being shaped are assembled into a layer of the cable. Moreover, they may act on different wires or wire groups (e.g. the wires of the first layer of the cable), as required. This embodiment also shows an alternative way of applying rolling force in different directions on the wires in the two reduction rolling steps, without rotating the wires themselves. In this embodiment, the guide roller 40 has grooves that guide the wires without twisting them through 90°. The rolls 28, 30 are oriented with their axes arranged vertically as shown, whereas the rolls 42, 44 retain their horizontal alignment. The wires 24A emerging from the rolls 28, 30 are all in a horizontal plane, but they rotate as a set to a vertical plane to pass between rolls 42, 44. Note that the set of wires rotate, but individual wires do not, so the angle at which the rolling force is applied to an individual wire changes by 90° because of the relative rotation of the rolls 28, 30 and 42, 44. The proper alignment of the wires 24A for entry between the rolls 42, 44 is assisted by additional guide rollers 39 and the grooved roller 40.

As an alternative to the use of shaping rolls 74, some (or all) of the grooves of the rolls 42, 44 may be made non-circular to impart a non-circular shape to the wires passing through those grooves.

It should also be noted that, although the area reduction rolls 28, 30, 32 and 44 are shown in the above embodiments as single rolls with multiple grooves, one for each individual wire, individual rolls for each wire may alternatively be provided. Such rolls are individual and designed to provide area reduction on only one wire at a time. They are used as a group of individual roll passes to provide the required final cable construction.

The following tables provide a theoretical assessment showing how input wires ofjust two standard sizes can be used to produce aluminum cable of many standard AWG sizes.

Table 1 is for input wires 24 having an outer diameter of 0.0982 inch (an area of 0.007574 square inches). The left column shows desired AWG cable sizes. The central columns show the reductions required in the first and second steps in order to achieve such cable sizes. The final column shows the cable sizes that can safely be predicted to be achievable (Yes) based on percentage wire area reductions, those that are doubtful (upper end of the reduction range) and those that are not feasible (No).

TABLE 1

| Compressed | | End wire | | Total % | Step 1 | Area after | Step 2 | |
|---|---|---|---|---|---|---|---|---|
| AWG | | Size | Area | Reduction | Reduction % | Step 1 | Reduction % | Achievability |
| | | Beginning | | | | | | |
| | | wire Size | Area | | | | | |
| | | 0.0982 | 0.007574 | | | | | |
| 2-7 | W | 0.0980 | 0.007543 | 0.41 | 0.00 | 0.007574 | 0.41 | Yes |
| 1-19 | W | 0.0700 | 0.003848 | 49.19 | 32.00 | 0.005150 | 22.28 | ? |
| 1/0-7 | W | 0.1240 | 0.012076 | −59.45 | 0.00 | 0.007574 | −59.45 | No |
| 1/0-19 | W | 0.0778 | 0.004754 | 37.23 | 25.00 | 0.005680 | 16.31 | Yes |
| 2/0-19 | W | 0.0882 | 0.00611 | 19.33 | 15.00 | 0.006438 | 5.09 | Yes |
| 3/0-19 | W | 0.0982 | 0.007574 | 0.00 | 0.00 | 0.007574 | 0.00 | Yes |
| 4/0-19 | W | 0.1085 | 0.009246 | −22.08 | 0.00 | 0.007574 | −22.08 | No |
| 250-37 | W | 0.0850 | 0.005675 | 25.08 | 20.00 | 0.006059 | 6.35 | Yes |
| 350-37 | W | 0.1014 | 0.008075 | −6.62 | 15.00 | 0.006438 | −25.44 | No |

Table 2 is a similar analysis carried out for wire having a starting size of 0.1240 inch (area 0.012076 sq. inch).

TABLE 2

| Compressed | | End wire | | Total % | Step 1 | Area after | Step 2 | |
|---|---|---|---|---|---|---|---|---|
| AWG | | Size | Area | Reduction | Reduction % | Step 1 | Reduction % | Achievability |
| | | Beginning | | | | | | |
| | | wire Size | Area | | | | | |
| | | 0.1240 | 0.012076 | | | | | |
| 2-7 | W | 0.0990 | 0.007698 | 36.26 | 25.00 | 0.009057 | 15.01 | Yes |
| 1-19 | W | 0.0703 | 0.003882 | 67.86 | 50.00 | 0.006038 | 35.72 | ? |
| 1/0-7 | W | 0.1240 | 0.012076 | 0.00 | 0.00 | 0.012076 | 0.00 | Yes |
| 1/0-19 | W | 0.0788 | 0.004877 | 59.62 | 40.00 | 0.007246 | 32.69 | ? |
| 2/0-19 | W | 0.0892 | 0.006249 | 48.25 | 35.00 | 0.007850 | 20.39 | Yes |
| 3/0-19 | W | 0.0992 | 0.007729 | 36.00 | 25.00 | 0.009057 | 14.67 | Yes |
| 4/0-19 | W | 0.1095 | 0.009417 | 22.02 | 15.00 | 0.010265 | 8.26 | Yes |
| 250-37 | W | 0.0860 | 0.005809 | 51.90 | 25.00 | 0.009057 | 35.87 | ? |
| 350-37 | W | 0.1024 | 0.008236 | 31.80 | 15.00 | 0.010265 | 19.77 | Yes |

It can be seen from Tables 1 and 2 that, by using just two input wires of different standard sizes, all of the indicated cable gauges can be produced by carrying out two wire area reduction steps in accordance with the present invention.

Although preferred embodiments of the invention have been described above, it will be apparent to persons skilled in the art that various modifications and alterations will be possible without departing from the underlying concept of the present invention, as defined in the following claims.

1. A method of producing at least two stranded aluminum cables of different gauge from aluminum wires all of the same initial cross-sectional area, which comprises assembling and stranding a first set of the wires all of the same initial cross-sectional area to form a first cable and subsequently assembling and stranding at least one other set of the wires all of the same initial cross-sectional area, and of the same initial cross-sectional area as the wires of the first set, to form at least one other cable, wherein, while assembling at least one set of the wires for the formation of at least one of the cables, the wires are reduced in cross-sectional area in at least two rolling steps, each rolling step causing a reduction in cross-sectional area of the wires less than an amount at which brittleness of the wires is produced.

2. The method of claim 1, wherein each rolling step causes a reduction in cross-sectional area of no more than 40%.

3. The method of claim 1, wherein each rolling step causes a reduction of cross-sectional area of no more than 30%.

4. The method of claim 1, wherein each rolling step causes a reduction of cross-sectional area of no more than 25%.

5. The method of claim 1, wherein a total reduction of cross-sectional area produced by said at least two rolling steps is 65% or less.

6. The method of claim 1, wherein, between each of said at least two rolling steps, the wires are axially rotated through and angle in the range of 45 to 135°.

7. The method of claim 1, wherein, between each of said at least two rolling steps, the wires are axially rotated by an angle of 85 to 95°.

8. The method of claim 1, wherein, a first of said at least two rolling steps imparts a non-circular cross-sectional shape to said wires, and a second of said at least two rolling steps imparts a circular cross-sectional shape to said wires.

9. The method of claim 8, wherein said non-circular cross-section is selected from the group consisting of oval and diamond-shape.

10. The method of claim 8, wherein said wires are rotated through 85 to 95° between said first and second rolling steps.

11. The method of claim 1, wherein there are only two of said rolling steps for each wire of said at least one set of wires.

12. The method of claim 1, wherein, following said rolling steps that cause said reduction of cross-sectional area, at least some of the wires of a set are subjected to a further rolling step that changes a cross-sectional shape of the wires to better fit within the cable formed from said wires.

13. The method of claim 1, wherein each of said cables is assembled with a central wire and at least one layer of wires surrounding said central wire.

14. The method of claim 13, wherein each cable has two layers of wires surrounding said central wire.

15. The method of claim 13, wherein each cable has a central wire, a first layer of six surrounding wires and a second layer of 12 surrounding wires.

16. The method of claim 1, wherein the wires are made of an aluminum alloy.

17. The method of claim 16, wherein the aluminum alloy is selected from the group consisting of AA1350, AA6201 and AA8000 aluminum alloy.

18. The method of claim 1, wherein the wires initially have an outer diameter selected from the group consisting of 0.0982 inch.

19. The method of claim 1, wherein the cables formed from the wires have an AWG gauge within the range of 8AWG to 1000 kcmil or a metric equivalent thereof.

20. The method of claim 18, wherein the cables formed from the wires have an AWG gauge selected from the group consisting of 1-19W, 1/0-19W, 2/0-19W, 250-37W and metric equivalents thereof.

21. The method of claim 1, wherein the wires initially have an outer diameter of 0.124 inch.

22. The method of claim 21, wherein the cables formed from the wires have an AWG gauge selected from the group consisting of 2-7W, 1/0-7W, 2/0-19W, 3/0-19W, 4/0-19W, and 350-37W and metric equivalents thereof.

23. The method of claim 1, wherein the cables are provided with a coating of electrically insulating material.

24. A method of producing at least two stranded aluminum cables of different gauge from aluminum wires all of the same initial cross-sectional area, which comprises assembling and stranding a first set of the wires to form a first cable and subsequently assembling and stranding at least one other set of the wires to form at least one other cable, wherein, prior to the assembling of at least one set of the wires for the formation of at least one of the cables, the wires are reduced in cross-sectional area in at least two rolling steps, each rolling step producing no more than 40% reduction of the cross-sectional area of the wire immediately prior to each rolling step.

25. A method of producing a stranded aluminum cable of desired final gauge, comprising the steps of: assembling a plurality of individual metal wires of the same initial cross-sectional area, rolling the wires in at least two rolling steps to reduce the initial cross-sectional area of the wires for compatibility with said desired final gauge of the cable, and stranding a cable from said wires of reduced cross-sectional area, wherein each rolling step causes a reduction in cross-sectional area of the wires less than an amount at which brittleness of the wires commences.

26. The method of claim 25, wherein each wire is rolled from said initial cross-sectional area to said reduced cross-sectional area in no more than four rolling steps.

27. The method of claim 25, wherein each wire is rolled from said initial cross-sectional area to said reduced cross-sectional in just two rolling steps.

28. The method of claim 25, wherein said plurality of wires is assembled into said cable by selecting a single wire as a core wire, and twisting a remainder of said wires around said core wire in one or more layers.

29. The method of claim 28, wherein said remainder of wires is twisted around said core wire to form two layers.

30. The method of claim 25, wherein eacn wire of said plurality of wires is rolled in a first rolling step from a circular cross-section to a non-circular cross-section and then rolled in a second rolling step to a circular cross-section.

31. The method of claim 30, wherein said non-circular cross-section is selected from the group consisting of an oval and a diamond-shape.

32. The method of claim 25, wherein said rolling steps involve passing each wire between a pair of rolls acting on said wire in a direction of force, and wherein the direction of force of one rolling step is rotated by approximately 90° compared to the direction of force of an immediately preceding or succeeding step.

33. The method of claim 25, wherein a lubricant is present on said wire prior to or during said rolling steps.

34. The method of claim 26, wherein said third rolling step shapes said wires to produce even layering of said wires on said core.

35. The method of claim 25, wherein said cable is subjected to a compacting or compression step.

36. The method of claim 25, wherein said wires are made of aluminum alloy.

37. The method of claim 25, wherein, following said assembling of said wires, said wires are twisted together by passing said wires through a double twisting machine.

38. Apparatus for producing a stranded metal cable, comprising a supply of metal wires all of the same initial cross-sectional area, equipment for assembling the wires for cable formation, and a machine for stranding the wires into a cable, the apparatus comprising at least two adjustable rolling passes positioned between said supply and said stranding machine, each rolling pass being configured for rolling each wire to reduce the cross-sectional area of the wire by an amount less than that at which brittleness of the wires is caused.

39. The apparatus of claim 38, wherein each rolling pass is configured to reduce the cross-sectional area of the wire by no more than 40% by each roll set immediately prior to advancement of the wires to the machine for stranding the wires into cable.

40. The apparatus of claim 38, wherein each rolling pass is configured to reduce the cross-sectional area of the wire by no more than 30% by each pass immediately prior to advancement of the wires to the machine for stranding the wires into cable.

41. The apparatus of claim 38, wherein each rolling pass is configured to reduce the cross-sectional area of the wire by no more than 25% by each pass immediately prior to advancement of the wires to the machine for stranding the wires into cable.

42. The apparatus of claim 38, having just two rolling passes for each wire.

43. The apparatus of claim 38, having three rolling passes for each wire.

44. The apparatus of claim 38, including means for axially rotating the wires between the rolling passes.

45. The apparatus of claim 38, wherein said means for axially rotating the wires rotates the wires through an angle of 45 to 135°.
